(19) United States
(12) Patent Application Publication
(10) Pub. No.: US 2006/0081523 A1
(43) Pub. Date: Apr. 20, 2006

(54) Device for separating impurities from liquids and a cleaning device

(75) Inventors: Knud Drohula, Hamburg (DE); Carsten Behnke, Hamburg (DE); Frank Fischer, Schenefeld (DE)

Correspondence Address: Friedrich Kueffner;Suite 910, 317 Madison Avenue, New York, NY, 10017, US

(73) Assignee: B + V Industrietechnik GmbH

(21) Appl. No.: 11/254,116

(22) Filed: Oct. 19, 2005

(30) Foreign Application Priority Data
Oct. 19, 2004 (DE) 10 2004 050 741.4

(51) Int. Cl. B01D 25/21

(52) U.S. Cl. 210/231; 210/498; 210/407

(57) ABSTRACT

A device for separating impurities from liquids for use in a separator for separating the impurities from an impurities/liquid mixture has a plate-shaped configuration in which at least two stacked plates are secured by a rod-shaped carrier centrally arranged relative to the plates. A cleaning device for cleaning such plate-shaped separating elements provided in a separator for separating impurities from an impurity/liquid mixture has a three-part configuration with a tub-shaped receiving unit, a cleaning unit, and a lid-shaped tray unit.

### BACKGROUND OF THE INVENTION

1. Field of the Invention

The invention relates to a device for separating impurities from liquids for use in a separating container for separating impurities from an impurities/liquid mixture. The device has a plate-shaped configuration.

The invention also relates to a cleaning device for cleaning plate-shaped separating elements that are used in the area of separators for separating impurities from an impurities/liquid mixture.

2. Description of the Related Art

Such separating devices serve for separating liquids or solids from a carrier liquid. In particular, it is possible to provide a separation of oil and water and to separate oil-like impurities from water in this way.

Typically, so-called oil separators are of a two-stage configuration. Separation of the oil is realized by using the effect of gravity based on different densities of the substances to be separated from one another as well as by using separating elements that assist in combining small and smallest contaminant particles to larger particles that can be more easily removed than very small particles. In particular, the separating elements serve for combining finely dispersed emulsified oil droplets to larger oil droplets that will rise in water. Moreover, the separating elements act like filters and retain finely dispersed solids that do not easily settle based on the effect of gravity.

In the area of a first separating stage of the oil separators, generally a plate-shaped separating element is positioned transversely to the flow direction. It is provided with fine passage channels or is comprised of a passable foam. This separating element provides the function of filtering finely dispersed contaminants as well as of combining small water droplets. In operation of the oil separator, it is required to clean the separating elements after a certain operating time. The duration of the utilization and cleaning cycles depends on the concrete application conditions and in particular on the amount of contaminants to be separated.

Based on the customary size of oil separators, it has not been possible in the past to optimize the functionality as well as ease of handling of the separating elements in such a way that, taking additionally into account economic boundary conditions, an optimization is achieved within the spectrum of demanded requirements.

### SUMMARY OF THE INVENTION

It is an object of the present invention to configure a device of the aforementioned kind such that a high functionality is obtained while at the same time easy handling is ensured.

In accordance with the present invention, this is achieved in that the plate-shaped configuration is comprised of at least two stacked plates and that the plates are secured by a rod-shaped carrier.

It is another object of the invention to configure a cleaning device of the aforementioned kind such that it is made easier to perform the cleaning process.

In accordance with the present invention, this is achieved in that a three-part configuration comprised of a tub-shaped receiving unit, a cleaning unit, and a lid-shaped tray unit is provided.

By means of the plate-shaped configuration of the separating element with a common rod-shaped carrier a high technical effectiveness as well as a simple handling are effected. By using the rod-shaped carrier, the separating element can be inserted into the oil separator and can also be removed from it. In particular, handling by means of lifting devices, for example, small cranes, is improved.

The three-part configuration of the cleaning device enables, on the one hand, stowing of the cleaning unit when not in use in a compact way that requires little space and, moreover, contamination of the surroundings of the oil separator when removing the separating element from the oil separator is substantially prevented.

Adaptation to different application requirements is facilitated in that in the area of the carrier at least three plates are arranged.

In order to assist small oil droplets in combining to larger ones, it is advantageous that at least one of the plates has a macro-porous structure.

A compact arrangement is provided when the plates are formed of substantially circular disks.

The handling by means of lifting devices is facilitated in that the carrier is arranged centrally in the area of the plates.

In order to provide a lightweight embodiment, it is proposed that the carrier be tubular.

The handling of the separating element by employing lifting devices is further improved in that the carrier is provided with at least one handling opening.

For facilitating manipulation of soft and mechanically rather unstable plates, it is proposed that the plates are supported on at least one holding plate that is mounted on the carrier.

An especially compact configuration of the cleaning device is provided in that a sidewall of the lid-shaped tray unit has an inner diameter that is greater than an outer diameter of a sidewall of the tub-shaped receiving unit.

The fact that the cleaning unit can be arranged in the receiving unit contributes to a compact stowing arrangement when the cleaning device is not in use; this also prevents contamination.

A further improvement of the compact configuration can be achieved in that the cleaning unit arranged in the receiving unit can be covered by the lid-shaped tray unit.

A high handling safety is achieved in that the receiving unit can be designed in such a way that it can be positioned on the cover of the separator.

A preferred application resides in that the separating container is designed for separating oil from water.

### BRIEF DESCRIPTION OF THE DRAWING

In the drawing:

FIG. 1 is a schematic side view of a two-stage separating device;

FIG. 2 is a vertical section of a multi-layer separating element with centrally arranged carrier;

FIG. 3 is a schematic illustration of a cleaning device arranged above an oil separator.

### DESCRIPTION OF THE PREFERRED EMBODIMENTS

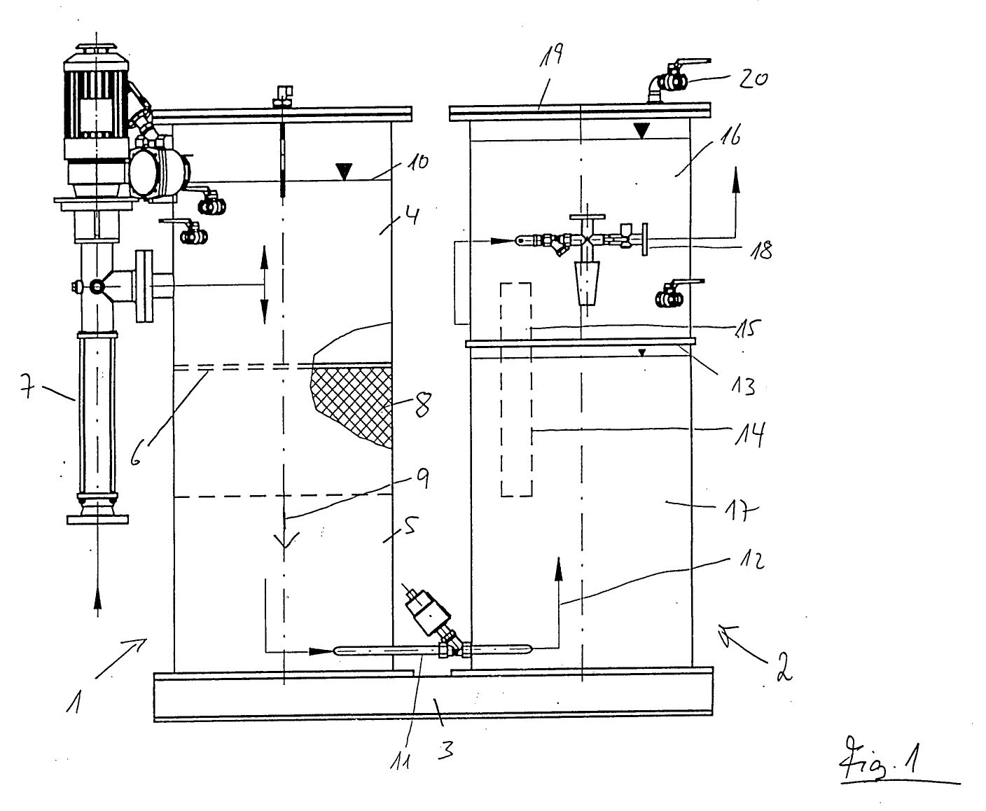

FIG. 1 shows schematically and partially in section a side view of a device for separating impurities from liquids, in particular for separating oil from water. The device has a first separating stage 1 as well as a second separating stage 2. The separating stages 1, 2 are secured on a common platform 3. The first separating stage 1 has an upper separating chamber 4 as well as a lower separating chamber 5 that are separated from one another by a mesh-like partition 6. An inlet 7 opens into the upper separating chamber 4. Below the partition 6 a separator 8 is arranged in the lower separating chamber 5. It is typically composed of a foamed or porous material. The main flow direction 9 in the first separating stage 1 is vertical from top to bottom.

Oil that has a lower density than the residual liquid collects as a result of gravity in the area of the liquid surface 10 in the upper separating chamber 4 of the first separating stage 1. The liquid flowing out of the first separating stage 1 is supplied by a connecting line 11 to the second separating stage 2. In the second separating stage 2, the main flow direction 12 is vertical from bottom to top. The second separating stage 2 is divided by a partition 13 that extends essentially-horizontally. In the area of the partition 13 a first separating element 14 and a second separating element 15 are secured. By means of the partition 13, the second separating stage 2 is divided into an upper separating chamber 16 and a lower separating chamber 17. An outlet 18 for the cleaned liquid is connected to the upper separating chamber 16. A discharge 20 for separated oil is arranged in the area of the cover 19 of the second separating stage 2.

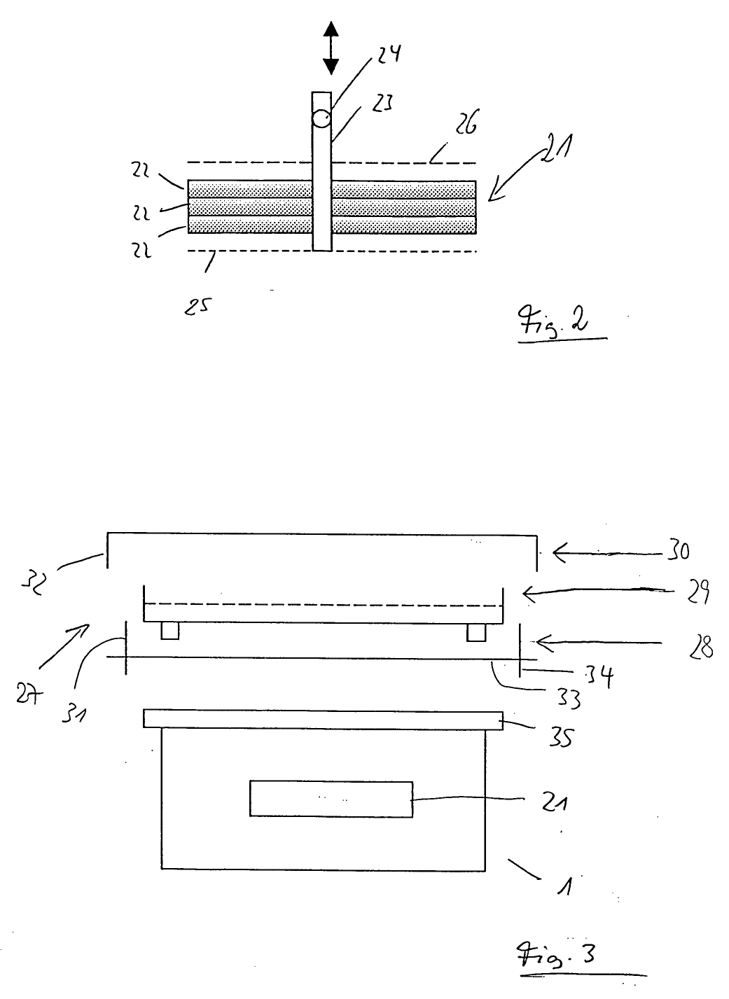

FIG. 2 shows a separating element 21 with plate-shaped configuration that can be used in the area of the first separating stage 1 as a separator 8. The separating element 21 is comprised in the embodiment illustrated in FIG. 2 of three stacked plates 22 that are secured by a rod-shaped carrier 23. The plates 22 are essentially circular disks with a central cutout. The carrier 23 is inserted into the central cutout. The carrier 23 can be tubular and is provided with at least one handling opening 24. Preferably, two handling openings 24 are provided in order to facilitate a connection to a lifting device, for example, a crane.

The plates 22 have a macro-porous structure. The thickness of the plates 22 is selected preferably to be different relative to one another and is matched to the respective application requirements.

For providing excellent mechanical stability, the plates 22 are positioned between two holding plates 25, 26 that have a perforated structure. In particular, it is suggested that at least the holding plate 25 that is the lower one in the vertical direction is rigidly connected to the carrier 23. The plates 22 can thus be loosely placed onto the carrier 23 and require thus only a relatively minimal mechanical stability on their own.

FIG. 3 shows a cleaning device 27 for the separator 8 or the separating element 21. The cleaning device is of a three-part configuration and is comprised of a tub-shaped receiving unit 28, a cleaning unit 29, and a lid-shaped tray unit 30. The cleaning unit 29 has an outer diameter that allows the cleaning unit 29 when not in use to be received in the receiving unit 28. A sidewall 33 of the tray unit 30 has an inner diameter that is greater than an outer diameter of a sidewall 31 of the receiving unit 28. The lid-shaped tray unit 30 can therefore be placed onto the receiving unit 28. The receiving unit 28 moreover has a bottom 33 that is provided in the area of its underside with a circumferential 34 whose inner diameter is matched to the outer diameter of a cover 35 of the first separating stage 1. The receiving unit 28 can therefore be placed in a mechanically stable way onto the cover 35.

For providing a compact stowing arrangement, it is possible to position the cleaning unit 29 when it is not in use on top of the cover 35. The cleaning unit 29 is inserted into the receiving unit 28 and covered by means of the lid-shaped tray unit 30.

For performing the cleaning process, first the cleaning device 27 is placed next to the first separating stage 1 and the tray unit 30 is removed and positioned in the area of a cleaning location. Subsequently, the cleaning unit 29 is removed from the receiving unit 29 and also positioned in the area of the cleaning location.

In the next step, the cover 35 is removed from the first separating stage 1 and the separating element 21 is pulled out of the first separating stage 1. Because of contaminants that drip out of the separating element 21, the separating element 21 first remains positioned vertically above the first separating stage 1. In the next step, the receiving unit 28 is placed onto the first separating stage 1 and the contaminated separating element 21 is inserted into the receiving unit 28. Subsequently, the receiving unit 28 is transported together with the separating element 21 to the cleaning location and the separating element 21 is then placed into the cleaning unit 29. After completion of the cleaning process, the cleaned separating element 21 is placed onto the tray unit 30.

When reassembling the separating stage 1, the separating element 21 is transported by the tray unit 30 to the first separating stage 1 and reinserted into the first separating stage 1. After placing the cover 35 on top, the operational state of the separating stage 1 is realized again. The cleaning device 27, optionally after having been cleaned, can be reassembled and positioned at its storage location.

While specific embodiments of the invention have been shown and described in detail to illustrate the inventive principles, it will be understood that the invention may be embodied otherwise without departing from such principles.

What is claimed is:

1. A separating element for separating impurities from liquids for use in a separator for separating the impurities from an impurities/liquid mixture, the separating element having a plate-shaped configuration comprised of at least two stacked plates and a rod-shaped carrier securing the at least two stacked plates.

2. The separating element according to claim 1, wherein at least three of the plates are arranged on the rod-shaped carrier.

3. The separating element according to claim 1, wherein at least one of the at least two plates has a macro-porous structure.

4. The separating element according to claim 1, wherein the at least two plates are substantially circular disks.

5. The separating element according to claim 1, wherein the carrier is essentially centrally arranged relative to the at least two plates.

6. The separating element according to claim 1, wherein the carrier is tubular.

7. The separating element according to claim 1, wherein the carrier has at least one handling opening.

8. The separating element according to claim 1, further comprising at least one holding plate connected to the rod-shaped carrier for supporting the at least two plates.

9. A cleaning device for cleaning plate-shaped separating elements which are provided in a separator for separating impurities from an impurity/liquid mixture, wherein the cleaning device has a three-part configuration comprised of a tub-shaped receiving unit, a cleaning unit, and a lid-shaped tray unit.

10. The cleaning device according to claim 9, wherein a sidewall of the lid-shaped tray unit has an inner diameter that is greater than an outer diameter of a sidewall of the tub-shaped receiving unit.

11. The cleaning device according to claim 9, wherein the cleaning unit is configured to be arranged within the receiving unit.

12. The cleaning device according to claim 9, wherein the lid-shaped tray unit is placed onto the receiving unit to cover the cleaning unit when the cleaning unit is arranged in the receiving unit.

13. The cleaning device according to claim 9, wherein the receiving unit is configured to be arranged on a cover of the separator.
